(19) United States
(12) Patent Application Publication
(10) Pub. No.: US 2018/0139100 A1
(43) Pub. Date: May 17, 2018

(54) STORAGE-AWARE DYNAMIC PLACEMENT OF VIRTUAL MACHINES

(71) Applicant: Nutanix, Inc., San Jose, CA (US)

(72) Inventors: Abhinay Ravinder Nagpal, San Jose, CA (US); Himanshu Shukla, San Jose, CA (US); Igor Grobman, San Jose, CA (US); Srinivas Bandi Ramesh Babu, Mountain View, CA (US); Aditya Ramesh, San Jose, CA (US)

(21) Appl. No.: 15/352,495

(22) Filed: Nov. 15, 2016

(51) Int. Cl. H04L 12/24

(52) U.S. Cl. CPC H04L 41/12; H04L 67/10; H04L 41/147

(57) ABSTRACT

In one embodiment, a system for placing virtual machines in a virtualization environment receives instructions to place a virtual machine within the virtualization environment, wherein the virtual environment includes a plurality of host machines that include a hypervisor, at least one user virtual machine, and an input/output (I/O) controller and a virtual disk that includes a plurality of storage devices and is accessible by all of the I/O controllers, wherein the I/O controllers conduct I/O transactions with the virtual disk based on I/O requests received from the UVMs. The system determines a predicted resource usage profile for the virtual machine. The system selects, based on the predicted resource usage profile, one of the host machines for placement of the virtual machine. The system places the virtual machine on the selected one of the host machines.

### TECHNICAL FIELD

This disclosure generally relates to placement of virtual machines within a virtualization environment.

### BACKGROUND

A “virtual machine” or a “VM” refers to a specific software-based implementation of a machine in a virtualization environment, in which the computing resources of a physical host machine (e.g., CPU, memory, etc.) are virtualized or transformed into the underlying support for the fully functional virtual machine that can run its own operating system and applications on the underlying computing resources just like a real computer.

Virtualization works by inserting a thin layer of software directly on the computer hardware or on a host operating system. This layer of software contains a virtual machine monitor or “hypervisor” that allocates the computing resources of the physical host machine dynamically and transparently to create and run one or more virtual machines. Multiple operating systems may thereby run concurrently on a single physical host machine and share computing resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single physical host machine, with each having access to the computing resources it needs when it needs them.

Virtualization allows one to run multiple virtual machines on a single physical host machine, with each virtual machine sharing the computing resources of that one physical host machine across multiple environments. Different virtual machines can run different operating systems and multiple applications on the same physical host machine.

One reason for the broad adoption of virtualization in modern business and computing environments is because of the resource utilization advantages provided by virtual machines. Without virtualization, if a physical host machine is limited to a single dedicated operating system, then during periods of inactivity by the dedicated operating system the physical machine is not utilized to perform useful work. This is wasteful and inefficient if there are users on other physical host machines which are currently waiting for computing resources. To address this problem, virtualization allows multiple VMs to share the underlying computing resources of the physical host machine so that during periods of inactivity by one VM, other VMs can take advantage of the resource availability to process workloads. This can produce great efficiencies for the utilization of physical host machines, and can result in reduced redundancies and better resource cost management.

Furthermore, there are now products that can aggregate multiple physical host machines into a larger system and run virtualization environments, not only to utilize the computing resources of the physical host machines, but also to aggregate the storage resources of the individual physical host machines to create a logical storage pool. With such a storage pool, the data may be distributed across multiple physical host machines in the system but appear to each virtual machine to be part of the physical host machine that the virtual machine is hosted on. Such systems may use metadata to locate the indicated data; the metadata itself may be distributed and replicated any number of times across the system. These systems are commonly referred to as clustered systems, wherein the resources of a cluster of nodes (e.g., the physical host machines) are pooled to provide a single logical system.

### SUMMARY OF PARTICULAR EMBODIMENTS

Embodiments of the present invention provide an architecture for managing input/output (I/O) operations and storage devices for a virtualization environment. According to some embodiments, a Controller/Service VM is employed to control and manage any type of storage device, including direct-attached storage in addition to network-attached and cloud-attached storage. The Controller/Service VM implements the Storage Controller logic in the user space, and with the help of other Controller/Service VMs running on physical host machines in a cluster, virtualizes all storage resources of the various physical host machines into one global logically-combined storage pool that is high in reliability, availability, and performance. Each Controller/Service VM may have one or more associated I/O controllers for handling network traffic between the Controller/Service VM and the storage pool.

In particular embodiments, a user VM (“UVM”) placement manager may determine the placement of UVMs. The UVM placement manager may place UVMs on a host machine according to a placement scheme that may determine placement for a UVM based on the predicted resource usage profile for the UVM or based on the available resources of the host machines.

Further details of aspects, objects, and advantages of the invention are described below in the detailed description, drawings, and claims. Both the foregoing general description and the following detailed description are exemplary and explanatory, and are not intended to be limiting as to the scope of the invention. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a clustered virtualization environment according to some embodiments of the invention.

FIG. 1B illustrates data flow within a clustered virtualization environment according to some embodiments of the invention.

FIG. 2 illustrates an example method for selecting a host machine in a cluster on which to place a particular VM, according to some embodiments of the invention.

FIG. 3 illustrates an example method for selecting a virtual machine to place on a host machine in a particular cluster, according to some embodiments of the invention.

FIG. 4 illustrates a block diagram of a computing system suitable for implementing an embodiment of the present invention.

### DESCRIPTION OF EXAMPLE EMBODIMENTS

Embodiments of the present invention provide an architecture for managing I/O operations and storage devices for a virtualization environment. According to some embodiments, a Controller/Service VM is employed to control and manage any type of storage device, including direct-attached storage in addition to network-attached and cloud-attached storage. The Controller/Service VM implements the Storage Controller logic in the user space, and with the help of other Controller/Service VMs running on physical host machines in a cluster, virtualizes all storage resources of the various physical host machines into one global logically-combined storage pool that is high in reliability, availability, and performance. Each Controller/Service VM may have one or more associated I/O controllers for handling network traffic between the Controller/Service VM and the storage pool.

In particular embodiments, a user VM (“UVM”) placement manager may determine the placement of UVMs. The UVM placement manager may place UVMs on a host machine according to a placement scheme that may determine placement for a UVM based on the predicted resource usage profile for the UVM or the available resources of the host machines.

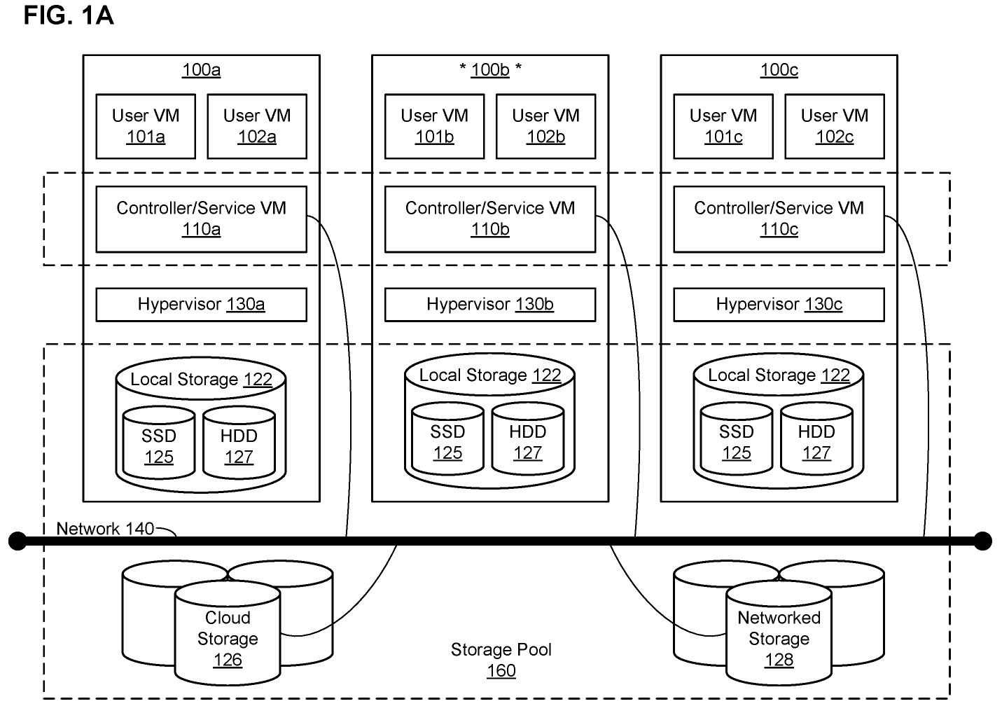

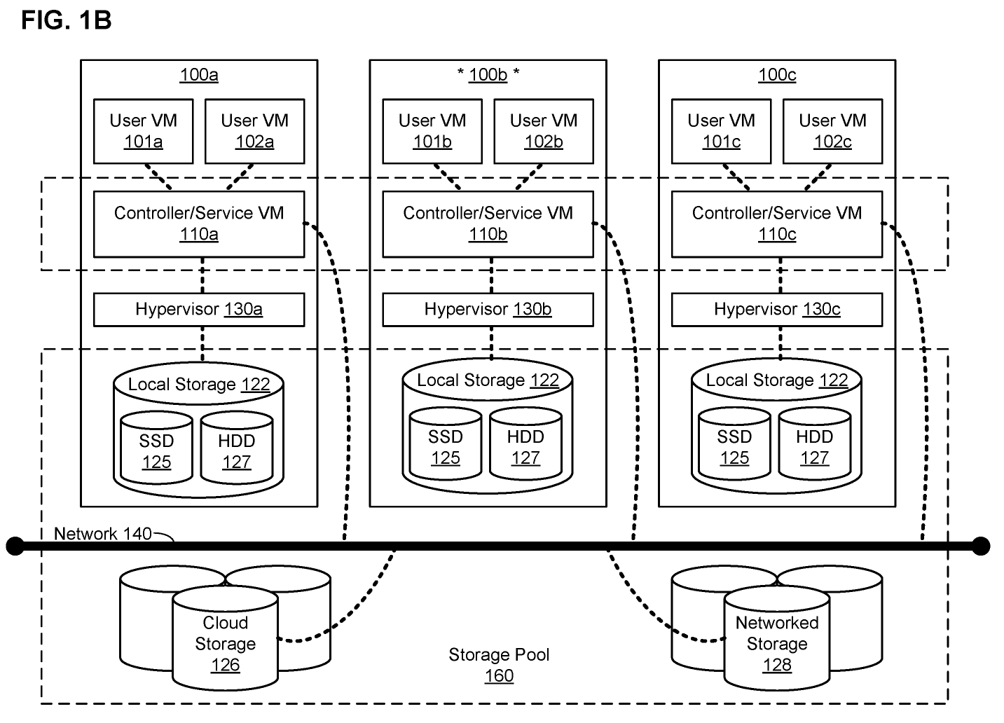

FIG. 1A illustrates a clustered virtualization environment according to some embodiments of the invention. The architecture of FIG. 1A can be implemented for a distributed platform that contains multiple host machines 100a-c that manage multiple tiers of storage. The multiple tiers of storage may include network-attached storage (NAS) that is accessible through network 140, such as, by way of example and not limitation, cloud storage 126, which may be accessible through the Internet, or local network-accessible storage 128 (e.g., a storage area network (SAN)). Unlike the prior art, the present embodiment also permits local storage 122 that is within or directly attached to the server and/or appliance to be managed as part of storage pool 160. Examples of such storage include Solid State Drives 125 (henceforth “SSDs”), Hard Disk Drives 127 (henceforth “HDDs” or “spindle drives”), optical disk drives, external drives (e.g., a storage device connected to a host machine via a native drive interface or a direct attach serial interface), or any other directly attached storage. These collected storage devices, both local and networked, form storage pool 160. Virtual disks (or “vDisks”) can be structured from the storage devices in storage pool 160, as described in more detail below. As used herein, the term vDisk refers to the storage abstraction that is exposed by a Controller/Service VM to be used by a user VM. In some embodiments, the vDisk is exposed via iSCSI (“internet small computer system interface”) or NFS (“network file system”) and is mounted as a virtual disk on the user VM.

Each host machine 100a-c runs virtualization software, such as VMWARE ESX(I), MICROSOFT HYPER-V, or REDHAT KVM. The virtualization software includes hypervisor 130a-c to manage the interactions between the underlying hardware and the one or more user VMs 101a, 102a, 101b, 102b, 101c, and 102c that run client software. Though not depicted in FIG. 1A, a hypervisor may connect to network 140. In particular embodiments, a host machine 100 may be a physical hardware computing device; in particular embodiments, a host machine 100 may be a virtual machine.

Special VMs 110a-c are used to manage storage and input/output (“I/O”) activities according to some embodiment of the invention, which are referred to herein as “Controller/Service VMs”. These special VMs act as the storage controller in the currently described architecture. Multiple such storage controllers coordinate within a cluster to form a single-system. Controller/Service VMs 110a-c are not formed as part of specific implementations of hypervisors 130a-c. Instead, the Controller/Service VMs run as virtual machines on the various host machines 100, and work together to form a distributed system 110 that manages all the storage resources, including local storage 122, networked storage 128, and cloud storage 126. The Controller/Service VMs may connect to network 140 directly, or via a hypervisor. Since the Controller/Service VMs run independent of hypervisors 130a-c, this means that the current approach can be used and implemented within any virtual machine architecture, since the Controller/Service VMs of embodiments of the invention can be used in conjunction with any hypervisor from any virtualization vendor.

A host machine may be designated as a leader node. For example, host machine 100b, as indicated by the asterisks, may be a leader node. A leader node may have a software component designated as a leader. For example, a software component of Controller/Service VM 110b may be designated as a leader. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node.

Each Controller/Service VM 110a-c exports one or more block devices or NFS server targets that appear as disks to user VMs 101a-c and 102a-c. These disks are virtual, since they are implemented by the software running inside Controller/Service VMs 110a-c. Thus, to user VMs 101a-c and 102a-c, Controller/Service VMs 110a-c appear to be exporting a clustered storage appliance that contains some disks. All user data (including the operating system) in the user VMs 101a-c and 102a-c reside on these virtual disks.

Significant performance advantages can be gained by allowing the virtualization system to access and utilize local storage 122 as disclosed herein. This is because I/O performance is typically much faster when performing access to local storage 122 as compared to performing access to networked storage 128 across a network 140. This faster performance for locally attached storage 124 can be increased even further by using certain types of optimized local storage devices, such as SSDs. Further details regarding methods and mechanisms for implementing the virtualization environment illustrated in FIG. 1A are described in U.S. Pat. No. 8,601,473, which is hereby incorporated by reference in its entirety.

FIG. 1B illustrates data flow within an example clustered virtualization environment according to some embodiments of the invention. As described above, one or more user VMs and a Controller/Service VM may run on each host machine 100 along with a hypervisor. As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 160. Additionally or alternatively, Controller/Service VM 110a-c may present an emulated storage controller either to the hypervisor or to user VMs to facilitate I/O operations. Controller/Service 110a-c may be connected to storage within storage pool 160. Controller/Service VM 110a may have the ability to perform I/O operations using local storage 122 within the same host machine 100a, by connecting via network 140 to cloud storage 126 or networked storage 128, or by connecting via network 140 to DAS 124b-c within another node 100b-c (e.g., via connecting to another Controller/Service VM 110b-c). In particular embodiments, any suitable computing system 400 may be used to implement a host machine 100.

In particular embodiments, UVM placement (e.g., the process of distributing a set of UVMs across multiple host machines) may be delegated to a UVM placement manager, which may initiate UVM placement as needed (e.g., by directing a hypervisor to create, suspend, resume, or destroy a UVM, by tracking the placement of UVMs across different host machines, by selecting the best location for a new UVM or an existing UVM that needs to be moved, etc.). In some embodiments, a UVM placement manager may place UVMs according to a placement scheme. A placement scheme may include predicting a resource usage profile for a UVM, determining available resources (e.g., CPU, memory, local storage resources, cache, networking devices) of a host machine, using a placement algorithm to select a host machine for placement of the UVM, or any combination thereof.

In particular embodiments, a UVM placement manager may monitor the architecture of the virtualization environment (e.g., host machines 100, storage pool 160, etc.) to determine available resources of a host machine. This may be based on historical resource usage data collected over time and/or a prediction of resources to be available at some time in the future. In particular embodiments, the assessment of past resource usage may be based on a designated period of time, e.g., the past day, week, month, or year. In particular embodiments, the determination of the available resources may be assessed as an average trend measured over a selected window of time (e.g., measuring the available resources on a host machine at a series of hourly checkpoints extending from Monday through Friday, where the measurement at each hour over the weekday period is averaged based on historical resource usage data collected over the last eight weeks).

In particular embodiments, a UVM placement manager may collect resource usage data for a UVM (e.g., disk storage required, processing power required, memory required, etc.). In some embodiments, such historical resource usage data may be assessed in order to predict a resource usage profile for a UVM. As an example and not by way of limitation, a predicted resource usage profile may include a number of different resource usage metrics, such as: (1) a predicted number of I/O operations per second (“IOPS”); (2) a predicted volume of I/O data transferred per second (“throughput”); (3) a predicted required response time from storage for a data type; (4) a predicted distribution of data into different types of storage media; (5) a predicted required type of storage media for a data type; (6) a predicted utilization of cache storage; or (7) any other predicted resource usage metric type or amount. The prediction may be based on a historical resource usage profile for the UVM, resource usage profiles for similar UVMs, known resource usage metrics for a suite of software that the UVM is configured to run, or any other suitable method of predicting a resource usage profile. In particular embodiments, the UVM placement manager may use different time scales when using historical resource usage profiles to predict a UVM's resource usage. For example, the UVM placement manager may analyze historical resource usage profiles for the prior day or the prior week to predict a future resource usage profile. In some embodiments, a UVM placement manager may predict whether a current resource usage metric of a resource usage profile is an outlier by comparing the current resource usage metric to historical resource usage metrics.

In particular embodiments, a UVM placement manager may use a placement algorithm to select a host machine for placement of a UVM. In particular embodiments, the placement algorithm may include a set of placement policies. Placement policies may be determined based on a predicted resource usage profile for the UVM. As an example and not by way of limitation, if the UVM was previously known to have typically used up to 80 gigabytes (GB) of storage, a placement policy may be that the host machine the UVM is to be placed on has at least 80 GB of local storage. As another example, if the UVM is configured to run a suite of software, such as 64-bit WINDOWS 10, that requires at least 2 GB of RAM memory, then a placement policy may be that the host machine the UVM is to be placed on has at least 2 GB of RAM that is unused.

In particular embodiments, a placement algorithm may select a host machine for placement of a UVM based on a solution to a bin packing problem. For example, the placement algorithm may be a next-fit algorithm, a next-fit decreasing algorithm, a first-fit algorithm, a first-fit decreasing algorithm, a best-fit algorithm, a best-fit decreasing algorithm, a worst-fit decreasing algorithm, the Martello and Toth algorithm, or any other suitable algorithm. In some embodiments, an algorithm may be an approximate solution to a bin packing problem. In some embodiments, a placement algorithm may use data structures such as a hierarchical tree or a graph model.

In particular embodiments, a UVM placement manager may place a UVM on a host machine based on the UVM's predicted IOPS and based on the host machine's actual or predicted available IOPS. As an example, host machine 100a may have local storage 122 that includes a mechanical hard drive with the capability of performing 92 IOPS. Host machine 100a may also have several other UVMs placed on it, which use a combined total of 11 IOPS, leaving 81 IOPS available. In this example, host machine 100b may have local storage 122 that includes an SSD with the capability of performing 5,000 IOPS, wherein host machine 100b currently has no UVMs placed on it. If the UVM is predicted to require 137 IOPS, then the UVM placement manager may place the UVM on host machine 100b because host machine 100b has the capability to perform the required number of IOPS.

In particular embodiments, a UVM placement manager may place a UVM on a host machine based on the UVM's predicted required throughput and based on the host machine's actual or predicted available throughput. As an example, host machine 100a may have an available throughput of 2 Gigabits per second (“Gbps”). In this example, host machine 100b may have a predicted available throughput of 1.5 Gbps, which may be predicted based on a prediction of the throughput requirements of other UVMs already placed on host machine 100b. If the UVM is predicted to require a throughput of 1.7 Gbps, then the UVM placement manager may place the UVM on host machine 100a because host machine 100a has an available throughput that exceeds the UVM's predicted throughout requirement.

In particular embodiments, a UVM placement manager may place a UVM on a host machine based on the UVM's predicted required amount of cache storage and based on the host machine's available amount of cache storage. Cache storage may refer to CPU cache memory, GPU cache memory, disk/page cache memory, or any other type of cache memory.

In particular embodiments, a UVM placement manager may place a UVM on a host machine based on the UVM's predicted required response time (e.g., the time it takes before a storage medium can transfer data, including seek time, rotational latency, and other factors) and based on the host machine's actual or predicted response time. In some embodiments, the host machine's actual or predicted response time may be based on the actual or predicted response time of a storage device utilized by the host machine. Additionally or alternatively, the host machine's predicted actual or predicted response time may also include the time delay in sending or receiving data over network 140 if the storage device utilized by the host machine is connected to the host machine over network 140 (e.g., cloud storage 126 or networked storage 128). For example, host machine 100a may use networked storage with a total response time of 23 milliseconds (ms) based on a 17 ms response time of the storage device and a 6 ms delay over network 140 between host machine 100a and the storage device. In this example, host machine 100b may use local storage with a total response time of 7.2 ms. If the UVM is predicted to run a software application that requires a low response time, then the UVM placement manager may place the UVM on host machine 100b because host machine 100b has a lower response time.

In particular embodiments, a UVM placement manager may dynamically move UVMs from one host machine to another host machine based on the UVM's resource usage profile and the comparative resource availability of the host machines. For example, a UVM may be initially placed on a host machine, and subsequently an actual or predicted resource usage metric of the UVM may increase beyond the actual or predicted capacity of the host machine. In such a case, a UVM placement manager may move the UVM to a new host machine with more available resources of the relevant type. In some embodiments, the UVM placement manager may, in response to CPU or memory contention on a given host machine that uses local storage, move the UVM on the original host machine that has the lowest IOPS or throughput usage to a new host machine.

In particular embodiments, a UVM may be pinned to a particular type of memory or a particular storage resource. For example, a user may select a UVM and request that the UVM be allocated 1 GB of flash memory on a local SSD of the host machine. In this example, data up to 1 GB that is written on the local SSD may remain “pinned” on the SSD, where the data might otherwise have been migrated to other forms of storage (e.g., DAS or networked storage). In some embodiments, a UVM placement manager may take into account any pinning while placing a UVM, by, for example, preferring to move UVMs that are not pinned, by ensuring that when placing a UVM with pinned memory that the destination host machine has the resources to comply with any pinning requests, etc.

In particular embodiments, a UVM may be suspended (e.g., saving the current state of the UVM to storage) and resumed (e.g., restoring a UVM to a saved state). In some embodiments, when resuming a UVM, a UVM placement manager may place the UVM on the same host machine that the UVM was placed on when suspended. In some embodiments, when resuming a UVM, a UVM manager may place the UVM based on whether the UVM is utilizing local storage of a host machine.

In particular embodiments, a UVM placement manager may receive data that indicates one or more host machines are unstable. In such cases, the UVM placement manager may place UVMs based on this information. For example, the UVM placement manager may not place a UVM on a host machine that is unstable, even if the host machine would otherwise have been suitable for placement of the UVM.

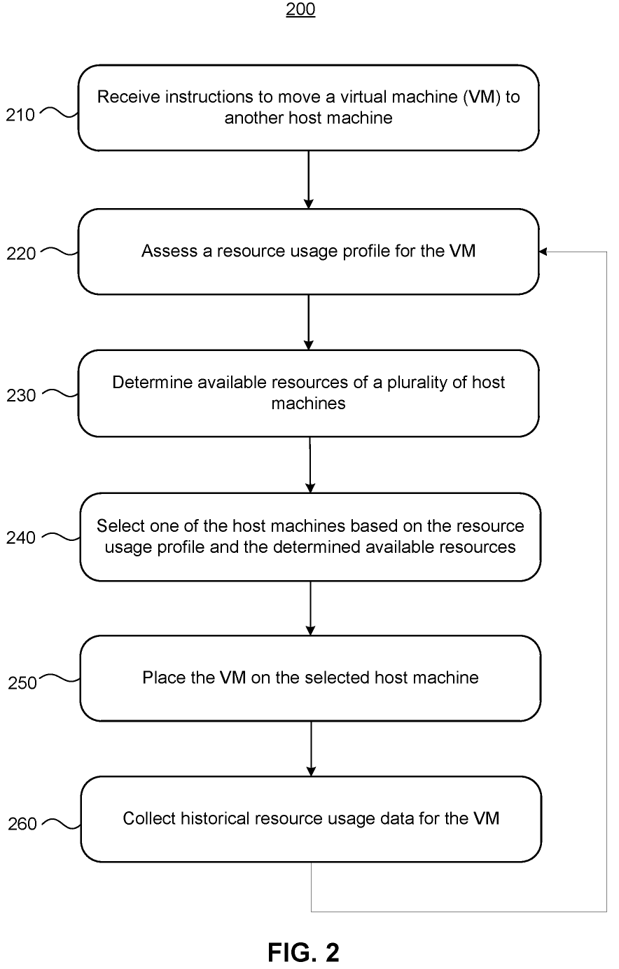

FIG. 2 illustrates an example method 200 for selecting a host machine in a cluster on which to place a particular VM, according to some embodiments of the invention. At step 210, the UVM placement manager may receive instructions to place a UVM. These instructions may include creating a UVM, moving a UVM between host machines, suspending a UVM, resuming a UVM, etc.

At step 220, the UVM placement manager may predict the resource usage profile for the UVM to be placed. In some embodiments, the predicted resource usage profile may be based on a historical resource usage profile for the UVM, resource usage profiles for similar UVMs, known resource usage metrics for a suite of software that the UVM is configured to run, or any other suitable method of predicting a resource usage profile. The resource usage profile may include resource usage metrics such as: (1) predicted IOPS; (2) predicted throughput; (3) a predicted required response time from storage for a data type; (4) a predicted distribution of data into different types of storage media; (5) a predicted required type of storage media for a data type; (6) a predicted utilization of cache storage; or (7) any other predicted resource usage metric type or amount.

At step 230, the UVM placement manager may determine available resources of a host machine. The available resources may represent resources available at a point in time or a prediction of available resources at some time in the future. As an example and not by way of limitations, available resources may include resource usage metrics such as: (1) predicted available IOPS; (2) predicted available throughput; (3) a predicted response time from storage for a data type; (4) a predicted type of available storage media; (5) predicted available cache storage; or (6) any other predicted available resource usage metric type or amount. In some embodiments, the UVM placement manager may retrieve stored data that can provide current or historical resource availability for a host machine or a current or historical resource usage profile for one or more UVMs placed on a host machine. In some embodiments, stored data may include an index that indexes hosts machines and provides their resource availability. Additionally or alternatively, available resources may be determined only when the UVM placement manager receives instructions to place a UVM. Although stored data or indexes may be discussed, this disclosure contemplates any suitable manner of determining available resources of host machines.

At step 240, the UVM placement manager may select a host machine based on the predicted resource usage profile of the UVM and available resources of the host machines. In particular embodiments, the UVM placement manager may use a placement algorithm, which may include placement policies, to select a host machine. In some embodiments, there may be several user-selectable placement algorithms or placement policies, which may represent different objectives. For example, there may be different placement algorithms or placement policies representing an objective to minimize the energy consumption by a distributed system, maximize the ratio between the number of placed UVMs and the number of host machines for a distributed system, minimize degradation of performance caused by the need to move UVMs from one host machine to another, prioritize the performance of particular UVMs, or any other appropriate objective. In some embodiments, one or more placement algorithms or placement policies may be predefined. Additionally or alternatively, a UVM placement manager may be configured to allow a user to define or create placement algorithms or placement policies. In particular embodiments, a placement algorithm or a placement policy may take into account heterogeneous UVMs (e.g., UVMs with different actual or predicted resource usage profiles) or heterogeneous host machines (e.g., host machines with different actual or predicted available resources). In step 250, the UVM placement manager may place the UVM on the selected host machine.

In step 260, the UVM placement manager may receive historical resource usage data (e.g., a historical resource usage profile for a UVM, historical available resources of a host machine, etc.). Historical resource usage data may be stored by the UVM placement manager.

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for connection management including the particular steps of the method of FIG. 2, this disclosure contemplates any suitable method for connection management including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

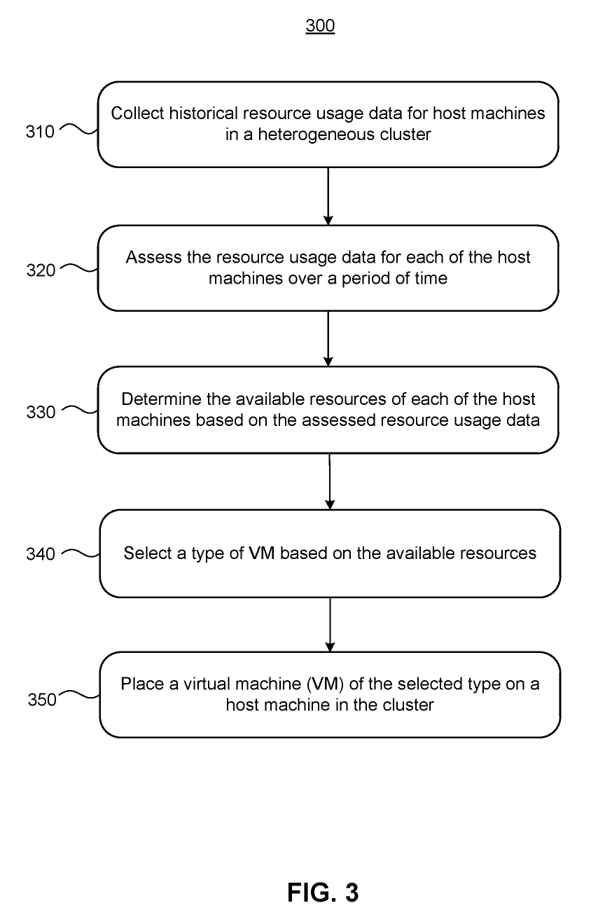

FIG. 3 illustrates an example method 300 for selecting a virtual machine to place on a host machine in a particular cluster, according to some embodiments of the invention. At step 310, the UVM placement manager may collect and store historical resource usage data regarding utilization and availability of resources of host machines in a heterogeneous cluster.

At step 320, the UVM placement manager may assess the resource usage data for each of the host machines over a period of time. In particular embodiments, the assessment of past resource usage may be based on a designated period of time, e.g., the past day, week, month, or year. In particular embodiments, the determination of the available resources may be assessed as an average trend measured over a selected window of time (e.g., measuring the available resources on a host machine at a series of hourly checkpoints extending from Monday through Friday, where the measurement at each hour over the weekday period is averaged based on historical resource usage data collected over the last eight weeks).

The resource usage data may include historical and projected data for resource usage metrics such as: (1) IOPS; (2) throughput; (3) a required response time from storage for a data type; (4) a distribution of data into different types of storage media; (5) a required type of storage media for a data type; (6) a utilization of cache storage; or (7) any other predicted resource usage metric type or amount.

At step 330, the UVM placement manager may determine the available resources of each of the host machines, based on the assessed resource usage data. This may be based on historical resource usage data collected over time and/or a prediction of resources to be available at some time in the future. The available resources may represent resources available at a point in time or a prediction of available resources at some time in the future. As an example and not by way of limitations, available resources may include resource usage metrics such as: (1) predicted available IOPS; (2) predicted available throughput; (3) a predicted response time from storage for a data type; (4) a predicted type of available storage media; (5) predicted available cache storage; or (6) any other predicted available resource usage metric type or amount. In some embodiments, the UVM placement manager may retrieve stored data that can provide current or historical resource availability for a host machine or a current or historical resource usage profile for one or more UVMs placed on a host machine. In some embodiments, stored data may include an index that indexes hosts machines and provides their resource availability. Additionally or alternatively, available resources may be determined only when the UVM placement manager receives instructions to place a UVM. Although stored data or indexes may be discussed, this disclosure contemplates any suitable manner of determining available resources of host machines.

At step 340, the UVM placement manager may select a particular VM based on the resources available on the host machines. In particular embodiments, the UVM placement manager may use a placement algorithm, which may include placement policies, to select a particular VM, including selecting a pre-determined type of VM and/or configuring a new VM according to a selected configuration. In some embodiments, there may be several user-selectable placement algorithms or placement policies, which may represent different objectives. For example, there may be different placement algorithms or placement policies representing an objective to minimize the energy consumption by a distributed system, maximize the ratio between the number of placed UVMs and the number of host machines for a distributed system, minimize degradation of performance caused by the need to move UVMs from one host machine to another, prioritize the performance of particular UVMs, or any other appropriate objective. In some embodiments, one or more placement algorithms or placement policies may be predefined. Additionally or alternatively, a UVM placement manager may be configured to allow a user to define or create placement algorithms or placement policies. In particular embodiments, a placement algorithm or a placement policy may take into account heterogeneous UVMs (e.g., UVMs with different actual or predicted resource usage profiles) or heterogeneous host machines (e.g., host machines with different actual or predicted available resources).

At step 350, the UVM placement manager may place the selected VM on a host machine in the cluster. In particular embodiments, the UVM placement manager may select the host machine on which to place the VM based on the available resources of the host machines in the cluster.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for connection management including the particular steps of the method of FIG. 3, this disclosure contemplates any suitable method for connection management including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

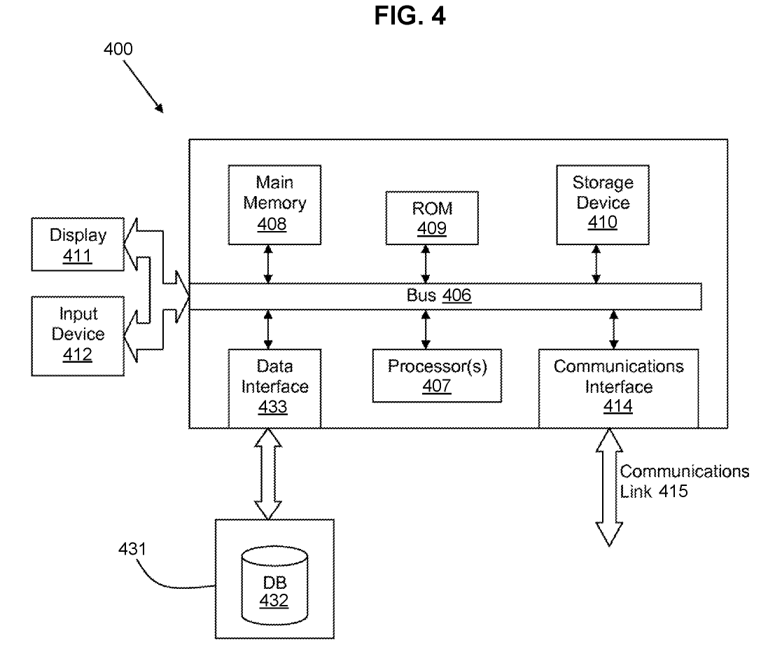

FIG. 4 is a block diagram of an illustrative computing system 400 suitable for implementing an embodiment of the present invention. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, a laptop or notebook computer system, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

Computer system 400 includes a bus 406 (e.g., an address bus and a data bus) or other communication mechanism for communicating information, which interconnects subsystems and devices, such as processor 407, system memory 408 (e.g., RAM), static storage device 409 (e.g., ROM), disk drive 410 (e.g., magnetic or optical), communication interface 414 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), display 411 (e.g., CRT, LCD, LED), input device 412 (e.g., keyboard, keypad, mouse, microphone). In particular embodiments, computer system 400 may include one or more of any such components.

According to one embodiment of the invention, computer system 400 performs specific operations by processor 407 executing one or more sequences of one or more instructions contained in system memory 408. Such instructions may be read into system memory 408 from another computer readable/usable medium, such as static storage device 409 or disk drive 410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 407 for execution. Such a medium may take many forms, including but not limited to, nonvolatile media and volatile media. Non-volatile media includes, for example, optical or magnetic disks, such as disk drive 410. Volatile media includes dynamic memory, such as system memory 408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 400. According to other embodiments of the invention, two or more computer systems 400 coupled by communication link 415 (e.g., LAN, PTSN, or wireless network) may perform the sequence of instructions required to practice the invention in coordination with one another.

Computer system 400 may transmit and receive messages, data, and instructions, including program, i.e., application code, through communication link 415 and communication interface 414. Received program code may be executed by processor 407 as it is received, and/or stored in disk drive 410, or other non-volatile storage for later execution. A database 432 in a storage medium 431 may be used to store data accessible by the system 400 by way of data interface 433.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method for placing virtual machines in a virtualization environment, comprising:
tracking resource consumption metrics over a designated period of time for a plurality of host machines in a cluster in a virtualization environment, the virtualization environment comprising:
the plurality of host machines, wherein each of the host machines comprises a hypervisor, at least one user virtual machine (UVM), and an input/output (I/O) controller; and
a virtual disk comprising a plurality of storage devices, the virtual disk being accessible by all of the I/O controllers, wherein the I/O controllers conduct I/O transactions with the virtual disk based on I/O requests received from the UVMs; and
selecting, based on the resource consumption metrics, one of the host machines for placement of a virtual machine; and
establishing the virtual machine on the selected one of the host machines.

2. The method of claim 1, wherein the resource consumption metrics for each of the host machines comprises:
an average number of I/O operations per second;
an average volume of I/O data transferred per second;
an average response time from storage for one or more types of data;
an average distribution of data into different types of storage media;
an average required type of storage media for one or more types of data; or
an average utilization of cache storage.

3. The method of claim 1, wherein the virtual machine is currently deactivated, and wherein the selecting one of the host machines for placement of the virtual machine is based on which of the host machines the virtual machine was last actively running.

4. The method of claim 1, wherein the establishing the virtual machine on the selected one of the host machines comprises moving the virtual machine from a current one of the host machines to a different one of the host machines, and wherein the predicted resource usage profile is determined based on historical information of resource usage metrics of the virtual machine on the current one of the host machines.

5. The method of claim 1, wherein the establishing the virtual machine on the selected one of the host machines comprises placing a new virtual machine on one of the host machines, wherein the new virtual machine will be configured to run a predetermined suite of software, and wherein the predicted resource usage profile is determined based on known resource usage metrics for the predetermined suite of software.

6. The method of claim 1, further comprising determining available resources of the host machines, wherein the selecting one of the host machines for placement of the virtual machine is further based on the available resources.

7. The method of claim 6, wherein the available resources of a host machine comprise:
a predicted available number of I/O operations per second;
a predicted available volume of I/O data transfer per second;
a predicted response time of a storage medium of the host machine;
a type of storage media available to the host machine; or
a predicted amount of available cache storage.

8. The method of claim 1, further comprising receiving a pinning request, wherein the selecting one of the host machines for placement of the virtual machine is further based on the pinning request.

9. The method of claim 1, further comprising accessing a placement policy, wherein the selecting one of the host machines for placement of the virtual machine is further based on the placement policy.

10. The method of claim 9, where the placement policy comprises an objective to:
minimize the energy consumption of the virtualization environment;
maximize the ratio between the number of placed virtual machines and the number of host machines in the virtualization environment;
minimize the need to move virtual machines from one host machine to another; or
prioritize the performance of one or more particular virtual machines in the virtualization environment.

11. One or more computer-readable non-transitory storage media embodying software that is operable when executed by one or more processors to:
track resource consumption metrics over a designated period of time for a plurality of host machines in a cluster in a virtualization environment, the virtualization environment comprising:
the plurality of host machines, wherein each of the host machines comprises a hypervisor, at least one user virtual machine (UVM), and an input/output (I/O) controller; and
a virtual disk comprising a plurality of storage devices, the virtual disk being accessible by all of the I/O controllers, wherein the I/O controllers conduct I/O transactions with the virtual disk based on I/O requests received from the UVMs; and
select, based on the resource consumption metrics, one of the host machines for placement of a virtual machine; and
establish the virtual machine on the selected one of the host machines.

12. The media of claim 11, wherein the resource consumption metrics for each of the host machines comprises:
an average number of I/O operations per second;
an average volume of I/O data transferred per second;
an average response time from storage for one or more types of data;
an average distribution of data into different types of storage media;
an average required type of storage media for one or more types of data; or
an average utilization of cache storage.

13. The media of claim 11, wherein the virtual machine is currently deactivated, and wherein the selecting one of the host machines for placement of the virtual machine is based on which of the host machines the virtual machine was last actively running.

14. The media of claim 11, wherein the software that is operable when executed by one or more processors to establish the virtual machine on the selected one of the host machines is further operable when executed to:
move the virtual machine from a current one of the host machines to a different one of the host machines, and wherein the predicted resource usage profile is determined based on historical information of resource usage metrics of the virtual machine on the current one of the host machines.

15. The media of claim 11, wherein the software that is operable when executed by one or more processors to establish the virtual machine on the selected one of the host machines is further operable when executed to:
place a new virtual machine on one of the host machines, wherein the new virtual machine will be configured to run a predetermined suite of software, and wherein the predicted resource usage profile is determined based on known resource usage metrics for the predetermined suite of software.

16. The media of claim 11, wherein the software is further operable when executed by one or more processors to:
determine available resources of the host machines, wherein the selecting one of the host machines for placement of the virtual machine is further based on the available resources.

17. The media of claim 16, wherein the available resources of a host machine comprise:
a predicted available number of I/O operations per second;
a predicted available volume of I/O data transfer per second;
a predicted response time of a storage medium of the host machine;
a type of storage media available to the host machine; or
a predicted amount of available cache storage.

18. The media of claim 11, wherein the software is further operable when executed by one or more processors to:
receive a pinning request, wherein the selecting one of the host machines for placement of the virtual machine is further based on the pinning request.

19. The media of claim 11, wherein the software is further operable when executed by one or more processors to:
access a placement policy, wherein the selecting one of the host machines for placement of the virtual machine is further based on the placement policy.

20. A system comprising one or more processors and a memory coupled to the processors comprising instructions executable by the processors, the processors being operable when executing the instructions to:
track resource consumption metrics over a designated period of time for a plurality of host machines in a cluster in a virtualization environment, the virtualization environment comprising:
the plurality of host machines, wherein each of the host machines comprises a hypervisor, at least one user virtual machine (UVM), and an input/output (I/O) controller; and
a virtual disk comprising a plurality of storage devices, the virtual disk being accessible by all of the I/O controllers, wherein the I/O controllers conduct I/O transactions with the virtual disk based on I/O requests received from the UVMs; and
select, based on the resource consumption metrics, one of the host machines for placement of a virtual machine; and
establish the virtual machine on the selected one of the host machines.
